(19) United States
(12) Patent Application Publication
(10) Pub. No.: US 2016/0294752 A1
(43) Pub. Date: Oct. 6, 2016

(54) MESSAGE MATCHING SYSTEMS AND MESSAGE MATCHING METHODS THEREOF

(71) Applicant: NATIONAL TSING HUA UNIVERSITY, Hsinchu (TW)

(72) Inventors: Shan-Hung Wu, Hsinchu City (TW); Chia-Hsin Yeh, Hsinchu (TW)

(21) Appl. No.: 14/794,745

(22) Filed: Jul. 8, 2015

(30) Foreign Application Priority Data
Mar. 30, 2015 (TW) 104110187

(51) Int. Cl. H04L 12/58

(52) U.S. Cl. CPC H04L 51/12

(57) ABSTRACT

Message matching methods for use in a message matching system are provided. The message matching system includes a first electronic device, a server and at least one second electronic device. The method includes the steps of: receiving, by the server, a first message from the first electronic device; finding, by the server, at least one second message corresponding to the first message from a database based on the content of the first message; determining, by the server, whether the at least one second message matches the first message; and if so, transmitting, by the server, the at least one second message to the first electronic device and the first message to a second electronic device corresponding to the at least one second message respectively, wherein the second message has content corresponding to that of the first message and is sent by an unknown source.

### CROSS REFERENCE TO RELATED APPLICATIONS

This application claims the benefit of Taiwan Patent Application No. 104110187, filed Mar. 30, 2015, the entirety of which is incorporated by reference herein.

### BACKGROUND OF THE INVENTION

1. Field of the Invention

The disclosure relates generally to message processing systems and methods, and, more particularly to anonymous message matching systems and message matching methods thereof capable of matching messages transmitted by anonymous users.

2. Description of the Related Art

Anonymous posting is a network interaction mode widely accepted by the public. Under this mode, users can freely express themselves. However, this type of posting mode also results in the generation of large amounts of spam. Users must spend considerable time to search posts that interest them, and their posts often fail to receive constructive responses.

Another way is to set up a group of friends or invite persons in public forums to enter the group and engage in information exchange. Although members within the group are able to see each other's messages, since users already know one anothers' identities, they tend to have second thoughts about what they write, thus resulting in untruthful contents.

### BRIEF SUMMARY OF THE INVENTION

Message matching systems and message matching methods thereof are provided.

In one embodiment, a message matching method for use in a message matching system is provided, wherein the message matching system comprises a first electronic device, a server and at least one second electronic device. The message matching method includes the following steps: receiving, by the server, a first message from the first electronic device; finding, by the server, at least one second message corresponding to the first message from a database based on the content of the first message; determining, by the server, whether the at least one second message matches the first message; and respectively transmitting, by the server, the at least one second message to the first electronic device and the first message to a second electronic device corresponding to the at least one second message when determining that the at least one second message matches the first message, wherein the at least one second message has content corresponding to that of the first message and is sent by an unknown source.

Another embodiment of the invention provides a message matching system including a first electronic device providing a first message, at least one second electronic device and a server connecting the first electronic device and at least one second electronic device, wherein the server has a database; wherein the server receives the first message from the first electronic device, finds at least one second message corresponding to the first message from the database based on the content of the first message, determines whether the at least one second message matches the first message and respectively transmits the at least one second message to the first electronic device and the first message to the at least one second electronic device corresponding to the at least one second message when determining that the at least one second message matches the first message, wherein the at least one second message has content corresponding to that of the first message and is sent by an unknown source.

Message matching methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a message matching system of the invention;

FIG. 2 is a flowchart of an embodiment of a message matching method of the invention;

FIG. 3 is a flowchart of another embodiment of a message matching method of the invention; and

FIG. 4 is a schematic diagram illustrating an embodiment of a message matching procedure of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide message matching systems and message matching method thereof, which can use anonymous message transmission and through a similarity matching algorithm to enable users sending messages to quickly find out those matching messages with similar interests with their own messages and with high quality guarantee. Moreover, the original authors of the messages being matched can also have a high probability for obtaining helpful and constructive responses.

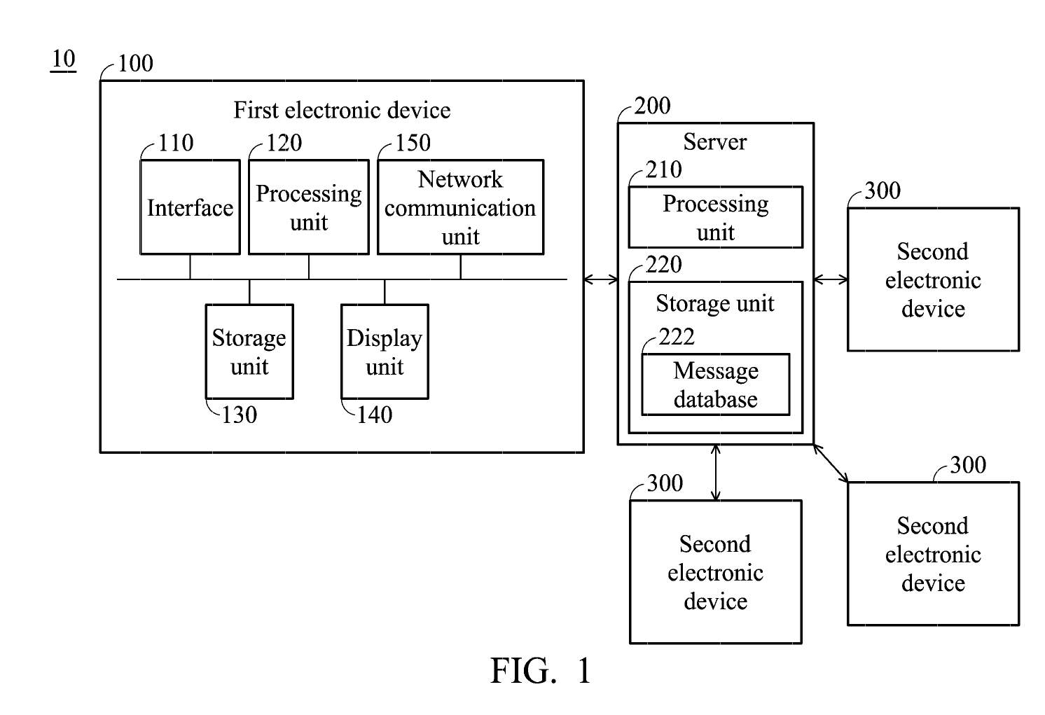

FIG. 1 is a schematic diagram illustrating an embodiment of a message matching system of the invention. As shown in FIG. 1, the message matching system 10 includes at least one first electronic device 100, a server 200 and one or more second electronic device(s) 300. The first electronic device 100 and the second electronic device(s) 300 may be the same portable device or other types of wireless devices with wireless communication capabilities, such as PDAs (Personal Digital Assistant), smartphones, mobile phones, MIDs (Mobile Internet Device), laptop computers, car computers, digital cameras, multi-media players, gaming devices, or any other type of mobile computational device, however it is to be understood that the invention is not limited thereto. The first electronic device 100 and the second electronic device(s) 300 may connect to the server 200 via a network, such as a wired network (e.g., the Internet) and/or a wireless network (e.g., a wireless code division multiple access (WCDMA), 3G, Wireless Local Area Network (WLAN) or Bluetooth network), to mutually execute communication and transfer data through the server 200.

The first electronic device 100 may at least comprise an interface 110, a processing unit 120, a storage unit 130, a display unit 140 and a network communication unit 150. The interface 110 is used for receiving related input messages. In some embodiments, the interface 110 may be a touch-sensitive device or a keyboard and the input message can be text data input by using the touch-sensitive device or the keyboard. In some embodiments, the interface 110 may be a microphone and the input message can be audio data received from the microphone. In some embodiments, the interface 110 may be an image capture device such as a CMOS or CCD camera and the input message can be image data captured by using the image capture device. It should be understood that, in some embodiments, the input message of the interface 110 can be videos, files, attachments and/or related data stored in the storage unit 130. However, it is to be understood that the invention is not limited thereto.

The storage unit 130 may be a built-in memory or an external memory card, which stores any type of data and provides data to the display unit 140 for display. For example, the storage unit 130 may be a High-Speed Random Access Memory (RAM) (e.g., Static Random Access Memory (SRAM), Dynamic Random Access Memory (DRAM) or the like) and/or a non-volatile memory (e.g., Flash memory) (not shown), which may include one or more types of computer readable media for storing related data. The display unit 140 may display related data, such as texts, figures, interfaces, and/or information (e.g., map information, user interface, message editing interface and other data). It should be understood that, in some embodiments, the display unit 140 may be a screen integrated with a touch-sensitive device (not shown). The touch-sensitive device has a touch-sensitive surface comprising sensors in at least one dimension to detect contact and movement of at least one object (input tool), such as a pen/stylus or finger near or on the touch-sensitive surface. Accordingly, users are able to input commands or signals via the display unit 140.

The network communication unit 150 is responsible for providing the function of wired or wireless network access, so that the first electronic device 100 may connect to the Internet or a particular service website set up on the Internet. The wired network access may include an Ethernet connection, an Asymmetric Digital Subscriber Line (ADSL), a cable connection, or the like. The wireless network access may include a connection to a Wireless Local Area Network (WLAN), a WCDMA system, a Code Division Multiple Access 2000 (CDMA-2000) net system work, a Time Division-Synchronous Code Division Multiple Access (TD-SCDMA) system, a Worldwide Interoperability for Microwave Access (WiMAX) system, a Long Term Evolution (LTE) system, an LTE Advanced (LTE-A) system, or a Time-Division LTE (TD-LTE) system. In some embodiments, the network communication unit 150 may further comprise a wireless transceiver (not shown). The wireless transceiver may further comprise a radio frequency (RF) unit (not shown) and a baseband unit (not shown). The baseband unit may contain multiple hardware components to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the mobile communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the radio access technology (RAT) in use. The processing unit 120 may further control the operation of the wireless transceiver and other functional components, such as the display unit 140 and/or keypad serving as the MMI (man-machine interface), the storage unit 130 storing the program codes of applications or communication protocols, or others.

The processing unit 120 which is coupled to the interface 110, the storage unit 130, the display unit 140 and the network communication unit 150 can perform the message matching method of the present invention, which will be discussed further in the following paragraphs. For example, the processing unit 120 may be one or more data processors, image processors and/or central processors, which are capable of executing one or more types of computer readable media stored in the storage unit 130 such as a memory. To be more specific, a user of the first electronic device 100 may generate a first message (such as a piece of text, photo, audio, or video) through the interface 110 of the first electronic device 100 and upload it to the server 200 to perform message matching through the server 200 so as to obtain another message. The server 200 may perform instant message matching based on the content of the first message to find a second message matched from the database. The server 200 may then send back the matched second message to the first electronic device 100 and send the first message to the second electronic device 300 that corresponds to the matched second message.

Similarly, the second electronic device 200 may also comprise an interface, a processing unit, a storage unit and a network communication unit (not shown) as the first electronic device 100, having functions and structures which are similar to those of the first electronic device 100, and thus details of which are omitted here for brevity. It should be appreciated that components of the first electronic device 100 and the second electronic device 200 can have sufficient hardware components to achieve the foregoing functions.

The server 200 may comprise a processing unit 210 and a storage unit 220, wherein the processing unit 210 is coupled to the storage unit 220 for performing the message matching method of the present invention, which will be discussed further in the following paragraphs. For example, the processing unit 210 may be one or more data processors, image processors and/or central processors, which are capable of executing one or more types of computer readable media stored in the storage unit 220 such as a memory. The storage unit 220 may be a built-in memory or an external memory card, which stores any type of data. The storage unit 220 may further comprise a message database 222 for storing related data, such as messages provided by each of the first electronic device 100 and the second electronic device(s) 300. For example, the storage unit 220 may be a High-Speed Random Access Memory (RAM) (e.g., Static Random Access Memory (SRAM), Dynamic Random Access Memory (DRAM) or the like) and/or a non-volatile memory (e.g., Flash memory) (not shown), which may include one or more types of computer readable medium for storing related data. In the following embodiments, for easy illustration, the user of the first electronic device 100 is also known as a first user, which is a matchmaker, while the user of the second electronic device 300 is also known as a second user, which is a user being matched. Note that since the invention involves anonymous sending, the first user of the first electronic device 100 and the second user of the second electronic device 300 will not know each other's true identity.

In some embodiments, embodiments of the message matching methods of the invention can apply a similarity matching algorithm to the content of the first message generated by the first user of the first electronic device 100 to automatically perform instant message matching with several most similar messages in the message database 220 to find a matching second message from the message database 222. Then, the second message matched is sent back to the first electronic device 100 immediately or within given time. At the same time, the first message is sent to the second electronic device 300 corresponding to the matching second message.

Thereafter, the first user of the first electronic device 100 can write comments for these matched messages, while the original author of the matched messages (i.e., the second user of the second electronic device 300) can read the comments and make replies. Since the message matching process is completely anonymous, users will not know each other's identity, thus increasing the chance of obtaining valuable comments that serve reference purposes.

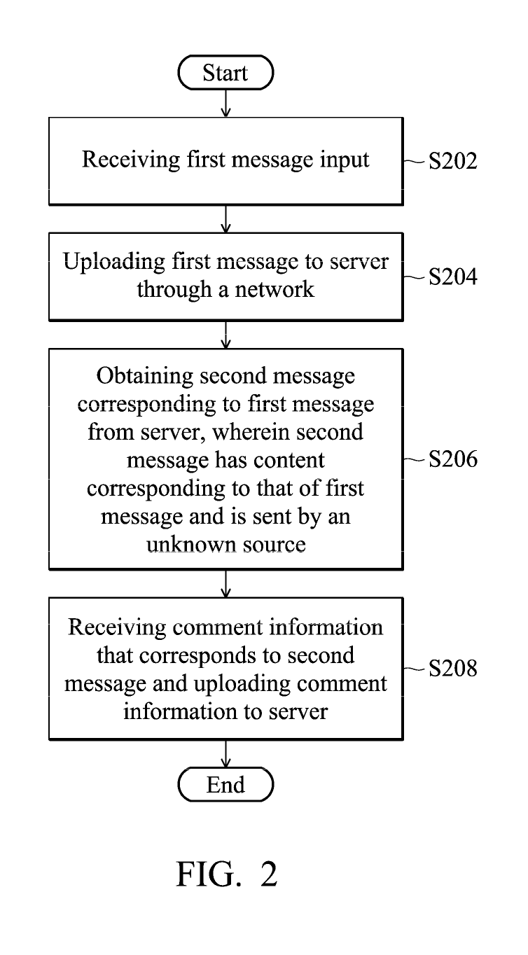

FIG. 2 is a flowchart of an embodiment of a message matching method of the invention. Please refer to FIGS. 1 and 2. The message matching method can be applied to an electronic device, such as a PDA (Personal Digital Assistant), a smart phone, a mobile phone, an MID (Mobile Internet Device), a laptop computer, a car computer, a digital camera, a multi-media player, a game device, or any other type of mobile computational device, however, it is to be understood that the invention is not limited thereto. For example, the message matching method can be applied to the first electronic device 100 and performed by the processing unit 120 as shown in Fig.1.

First, in step S202, when the first user of the first electronic device 100 inputs a first message, the processing unit 120 receives the first message input. The first message may contain text, photo, recorded audio, or video, or a combination thereof, such as a piece of text, photo, recorded audio, or video. In some embodiments, the first message can be received by an interface, such as a touch-sensitive device, a keyboard, a microphone, or an image capture unit however, it is to be understood that the invention is not limited thereto. In step S204, the first message is uploaded to the server 200 through a network such as the Internet via the network communication unit 150. Subsequently, in step S206, a second message corresponding to the first message is obtained from the server 200 through the network. In particular, the second message has content corresponding to that of the first message and is sent from an unknown/hidden source. To be more specific, the first electronic device 100 is connected to a network (e.g., the Internet) and communicates with the server 200 on the network to upload the first message to the server 200.

After receiving the first message, the server 200 stores the first message to the message database 222 of the storage unit 220. Then, based on the content of the first message such as keywords or identification data, the server 200 performs message matching using the similarity matching algorithm to find at least one second message which has an article associated with the first message (such as a similar situation) and is uploaded by the second user using the anonymous name through the second electronic device 300. And, the second message found is sent back to the first user of the first electronic device 100 through the network. Since the second user sends the message by anonymous transmission, its source can be regarded as an unknown/hidden source.

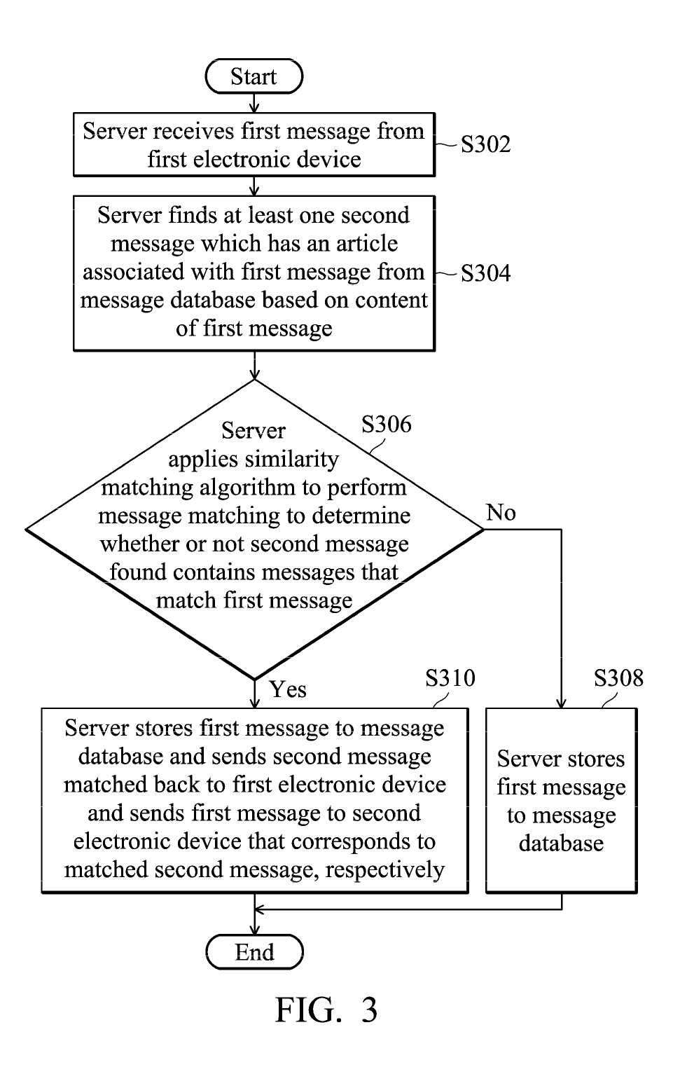

FIG. 3 is a flowchart of another embodiment of a message matching method of the invention. Please refer to FIGS. 1 and 3. The message matching method can be applied to a server, such as the server 200 and performed by the processing unit 210 as shown in Fig.1. In this embodiment, it is assumed that the message database 222 of the server 200 has stored a number of records recording second messages uploaded by the users of different second electronic devices 300.

First, after the server 200 receives the first message from the first electronic device 100 (step S302), the processing unit 210 analyzes the content of the first message and find at least one second message which has an article associated with the first message (such as a similar situation) and is uploaded by the second user using the anonymous name through the second electronic device 300 based on the keywords or identification data corresponding to the first message (step S304). Subsequently, the processing unit 210 applies the similarity matching algorithm to perform message matching to determine whether or not the second message found contains messages that match the first message (step S306). When the second message found contains no message that matches the first message (No in step S306), it means there is no message content suitable for exchange in the current message database 222 and thus the processing unit 210 stores the first message to the message database 222 instead (step S308). When the second message found contains at least one message that matches the first message (Yes in step S306), in addition to storing the first message in the message database 222, the processing unit 210 sends the second message matched back to the first electronic device 100 through the network and sends the first message to the second electronic device 300 that corresponds to the matched second message, respectively (step S310).

Referring back to FIG. 2, after the second message corresponding to the first message from the server 200 is obtained through the network, in step S208, the first user of first electronic device 100 can read the second message and write comment information after reading. Thus, the processing unit 120 receives comment information that corresponds to the second message and uploads the comment information to the server 200 so as to transfer it to the second user on the second electronic device 300 through the server 200. The second user can further provide a reply based on the comment information. Similarly, the second user of the second electronic device 300 can read the first message, write comment information after reading, and upload the comment information to the server 200 so as to transfer it to the first user on the first electronic device 100 through the server 200. The first user can further provide reply information based on the comment information. Since the above-mentioned message matching process involved is completely anonymous, the users will not know who the original writers are. Therefore, more comments that are valuable as references will likely be obtained to provide inspiration.

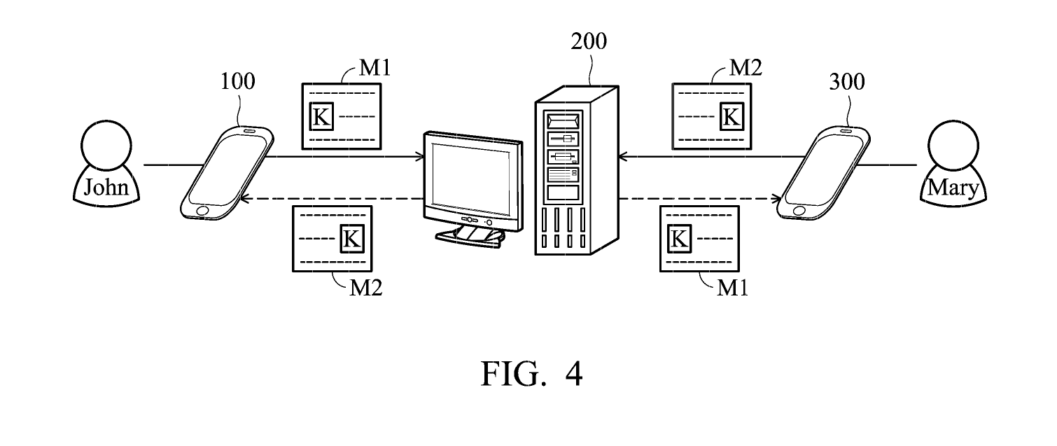

For example, refer to FIG. 4, which is a schematic diagram illustrating an embodiment of a message matching procedure of the invention. As shown in FIG. 4, assuming a user John of the first electronic device 100 inputs a first message M1 containing keywords K through an input tool, the content of which contains the text “I found money. What should I do? Should I take it to the police or keep it?” and uploads the first message M1 to the server 200, the processing unit 120 can upload the first message M1 to the server 200 through the Internet. For example, in this embodiment, the keywords K may contain word strings “found money” and “what to do”.

After receiving the first message Ml, the server 200 first stores it into the message database 222 through the processing unit 210. Then, according to the content in the first message M1 such as the keywords K “found money” and “what to do”, the processing unit 210 searches the message database 222 to find whether there is a second message that conforms to or is similar to this content. For example, the message database 222 is searched to find any second message containing keywords K with related content. In this embodiment, assume that a user Mary of one second electronic device 300 has already uploaded, to the server 200, a second message M2 containing contents corresponding to the keywords K, the content of which contains the text “I found money. I waited a while at the place I found it, but I did not see the owner of the money coming back for the money. So, I took it to the Police Station”. The server 200 then sends the second message M2 provided by the user Mary to the first electronic device 100 for the user John to read. Meanwhile, the server 200 also sends the first message provided by the user John to the second electronic device 300 for the user Mary to read, as shown in dotted lines of FIG. 4. The user John may write and send comment information I such as “It seems the money should be taken to the police station” after reading the second message M2, and thus the first electronic device 100 may then receive the comment information I corresponding to the second message M2 and upload the comment information I to the server 200 through the network.

The server 200 may then send related comment information I to the second electronic device 300 that corresponds to the second message M2, so that the user Mary of the second electronic device 300 can read and reply to the comments.

Therefore, the message matching systems and message matching methods thereof of the invention can be used to engage in information exchange among anonymous users. Information exchanged is related to the content of messages written (such as a similar situation), which are messages uploaded by the second user using the anonymous name of another through an electronic device. After the message exchange between the two parties, messages are sent to the original writer, thereby achieving the purpose of exchange. Since the aforementioned exchange is done anonymously, the two parties engaged in the exchange will not know each other's identity. By doing so, users not only can learn how others handle situations similar to their own, but will also be risk-free when it comes to information disclosure due to the anonymity of the system. Therefore, users can freely express their ideas and write true rather than fictitious content.

In some embodiments, the message matching systems and message matching methods thereof of the invention may further provide a masking tool (such as a mosaic tool) to enable users to selectively mask content (such as names) not to be disclosed through the said masking tool in order to protect privacy.

In some embodiments, the message matching systems and message matching methods thereof of the invention may further provide a scoring function used to generate scores by statistical means based on the frequency, popularity, and accuracy of data uploaded by the users. The higher the score of the user, the more authorization and added functions the user is entitled to. The scoring mechanism encourages users to write better contents. Due to the special exchange mechanism, the higher the quality of messages written by the user, the higher the user's chance of getting high-quality messages. For example, when the score of the user exceeds a predetermined threshold, added functions such as the subscription function described below will be open for access, thereby encouraging users to write truthful and better content in order to receive better contents in return.

In some embodiments, the message matching systems and message matching methods thereof of the invention may further provide the subscription function. With the subscription function opened, after the first user of the first electronic device exchanges information with the specific user of the second electronic device, the first user will be allowed to subscribe message content coming from the specific second user. The information matching system may then prioritize providing related messages sent by the specific second user to the first user. It should be understood that even through the subscription mechanism of the invention, messages written by the second user are still sent to the first user by anonymous means. This means the identity of the second user will still not be known to the first user, thus achieving privacy of information.

In some embodiments, the message matching systems and message matching methods thereof of the invention may further provide a communication platform that enables users to switch the message exchanges among users from one-to-many exchanges to one-to-one exchanges. Subsequently, upon agreement of both parties, the communication platform provides a platform for subsequent development, such as exchanging real identification information or contact information, thereby switching from anonymous exchanges into identified/known/named exchanges.

Therefore, according to the message matching systems and message matching methods thereof of the invention, through conditioned anonymous exchange, users can acquire messages that are similar to their own encounters, without having to worry about disclosure of identity so that the users can pay more attention to writing messages in exchange for higher quality and better information. Additionally, the characteristics of anonymity can increase the probability of users' supply of private and truthful contents, thus making the contents of the messages exchanged more valuable as references.

The embodiments of message matching that have been described, or certain aspects or portions thereof, may be practiced in logic circuits, or may take the form of program code (i.e., instructions) embodied in tangible media, such as floppy diskettes, CD-ROMS, hard drives, or any other machine-readable storage medium, wherein, when the program codes are loaded into and executed by a machine, such as a smart phone, a mobile phone, or a similar device, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A message matching method for use in a message matching system, wherein the message matching system comprises a first electronic device, a server and at least one second electronic device, the message matching method comprising:
receiving, by the server, a first message from the first electronic device;
finding, by the server, at least one second message corresponding to the first message from a database based on the content of the first message;
determining, by the server, whether the at least one second message matches the first message; and
respectively transmitting, by the server, the at least one second message to the first electronic device and the first message to a second electronic device corresponding to the at least one second message when determining that the at least one second message matches the first message,
wherein the at least one second message has content corresponding to that of the first message and is sent by an unknown source.

2. The message matching method of claim 1, wherein the server further finds the at least one second message corresponding to the first message from the database based on the content of the first message by using a keyword or identification information within the content of the first message to query the database to obtain the at least one second message.

3. The message matching method of claim 1, wherein the first electronic device receives the first message through an interface.

4. The message matching method of claim 3, wherein the interface comprises a touch-sensitive device, a keyboard, a microphone or an image capture device.

5. The message matching method of claim 1, wherein the server further determines whether the at least one second message matches the first message by applying a similarity matching algorithm on the first message and the at least one second message to compare the first message with the at least one second message.

6. The message matching method of claim 1, further comprising:
uploading, by the first electronic device, comment information corresponding to the at least one second message to the server so as to send the comment information to the second electronic device via the server after the at least one second message is received.

7. The message matching method of claim 6, further comprising:
uploading, by the second electronic device, a reply corresponding to the comment information to the server so as to send the reply to the first electronic device via the server after the comment information is received.

8. A message matching system, comprising:
a first electronic device, providing a first message;
at least one second electronic device; and
a server, connecting the first electronic device and at least one second electronic device, wherein the server has a database;
wherein the server receives the first message from the first electronic device, finds at least one second message corresponding to the first message from the database based on the content of the first message, determines whether the at least one second message matches the first message and respectively transmits the at least one second message to the first electronic device and the first message to the at least one second electronic device corresponding to the at least one second message when determining that the at least one second message matches the first message,
wherein the at least one second message has content corresponding to that of the first message and is sent by an unknown source.

9. The message matching system of claim 8, wherein the server further finds the at least one second message corresponding to the first message from the database based on the content of the first message by using a keyword or identification information within the content of the first message to query the database to obtain the at least one second message.

10. The message matching system of claim 9, wherein the first electronic device receives the first message through an interface.

11. The message matching system of claim 10, wherein the interface comprises a touch-sensitive device, a keyboard, a microphone or an image capture device.

12. The message matching system of claim 10, wherein the server further determines whether the at least one second message matches the first message by applying a similarity matching algorithm on the first message and the at least one second message to compare the first message with the at least one second message.

13. The message matching system of claim 8, wherein the first electronic device further uploads comment information corresponding to the at least one second message to the server so as to send the comment information to the second electronic device via the server after the at least one second message is received.

14. The message matching system of claim 8, wherein the second electronic device further uploads a reply corresponding to the comment information to the server so as to send the reply to the first electronic device via the server after the comment information is received.
